(19) United States
(12) Patent Application Publication
(10) Pub. No.: US 2013/0135384 A1
(43) Pub. Date: May 30, 2013

(54) PHOTOCURABLE INK COMPOSITION FOR INK JET RECORDING

(71) Applicant: SEIKO ESPON CORPORATION, Tokyo (JP)

(72) Inventor: Takashi OYANAGI, Matsumoto-shi (JP)

(73) Assignee: SEIKO ESPON CORPORATION, Tokyo (JP)

(21) Appl. No.: 13/746,797

(22) Filed: Jan. 22, 2013

Related U.S. Application Data
(62) Division of application No. 12/533,419, filed on Jul. 31, 2009.

(30) Foreign Application Priority Data
Aug. 11, 2008 (JP) 2008-206739

(51) Int. Cl. C09D 11/00

(52) U.S. Cl. CPC C09D 11/30
USPC 347/20

(57) ABSTRACT

A photocurable ink composition for ink jet recording includes a metallic pigment, a polymerizable compound, and a polymerization initiator. The metallic pigment is a plate-like particle composed of a laminate including a metal or alloy layer and at least one selected from a resin layer and a silicon oxide layer.

### CROSS REFERENCE APPLICATIONS

This application is a divisional of U.S. patent application Ser. No. 12/533,419 filed Jul. 31, 2009, which claims the benefit of Japanese Application No. JP2008-206739 filed Aug. 11, 2008, the content of which is incorporated herein by reference.

### BACKGROUND

1. Technical Field

The present invention relates to a photocurable ink composition for ink jet recording.

2. Related Art

In recent years, demand for printed matter having a glossy metallic surface on a printed surface has been increasing. Printed matter having a glossy metallic surface has been prepared by, for example, printing foil on a recording medium having a highly even printing surface, vacuum-depositing a metal on a plastic film having a smooth printing surface, or subjecting a recording medium printed with a metallic pigment ink to pressing.

Incidentally, in the ink jet recording method, printing is performed by that droplets of an ink composition fly to adhere to a recoding medium such as paper. This recording method has a feature that a high-resolution and high-quality image can be printed at a high speed with an apparatus having a relatively small structure. Accordingly, it has been investigated to produce recorded matter having a glossy metallic surface by the ink jet recording method. For example, JP-A-2002-179960 discloses a printing technique in which an ink composition containing, as a pigment, metal-coated spherical plastic particles is applied to a recording medium with an ink jet recording apparatus and then the surface is smoothed by pressing.

At the same time, recently, photocurable ink, which is cured by irradiation with light such as ultraviolet light, has been being investigated. The photocurable ink has features of drying quickly and being capable of recording on a nonabsorptive medium that does not absorb ink, such as a plastic, with less ink bleed. The photocurable ink is composed of a polymerizable compound, a polymerization initiator, a pigment, and so on.

There is a possibility that a glossy metallic surface can be formed without requiring a process such as pressing in the ink jet recording method by using a metallic pigment as the pigment of photocurable ink. However, in order to realize such a method, there are the following problems.

One problem is that the size of the metallic pigment is restricted. The metallic pigment necessarily has a diameter smaller than the nozzle diameter of an ink jet recording apparatus used in the ink jet recording method. This makes it difficult to obtain a printed surface having sufficient metallic gloss.

Another problem is that the curing of a printed ink surface is slow. In the use of a metallic pigment as the pigment of photocurable ink, even if the printed ink surface is irradiated with light, the metallic pigment absorbs or reflects the light, resulting in shortage of light. This causes insufficient curing of the printed surface, in some cases. Furthermore, when the photocuring mechanism is a cationic polymerization system, the generated acid reacts with the metal, which is dangerous. In addition, degradation of the metallic pigment prevents the formation of a desired glossy, metallic-looking image.

Furthermore, irradiation with high-intensity light for sufficiently curing the photocurable ink containing the metallic pigment causes troubles such that the recording medium is damaged by the heat generated by the light absorbed in the metallic pigment and that the light scattered to the surroundings by reflection may harm the safety.

Furthermore, there is a problem that the apparatus is grown in size. The light source for irradiation of high-intensity light becomes large in size, which leads to lost of the advantage that the apparatus for the ink jet recording method can have a structure that is compact and safe compared to those for other printing methods.

### SUMMARY

An advantage of some aspects of the invention is to provide a photocurable ink composition for ink jet recording that allows to readily form a glossy metallic surface having satisfactory glossiness and to be suitably applied to an ink jet recording method.

The photocurable ink composition for ink jet recording according to the invention includes a metallic pigment, a polymerizable compound, and a polymerization initiator. The metallic pigment is a plate-like particle composed of a laminate including a metal or alloy layer and one or both of a resin layer and a silicon oxide layer.

Such a photocurable ink composition for ink jet recording can readily form a glossy metallic surface having satisfactory glossiness and can be suitably applied to the ink jet recording method.

In the photocurable ink composition for ink jet recording according to the invention, the metallic pigment may further include a color material layer between the metal or alloy layer and the resin layer or the silicon oxide layer.

In the photocurable ink composition for ink jet recording according to the invention, the plate-like particle has a shape having a flat surface with a major axis X and a minor axis Y and a thickness Z that satisfy the requirements that the 50% average particle diameter R50 based on a circle-equivalent diameter determined from the X-Y plane area of the plate-like particle is 0.5 to 3 μm and R50/Z>5.

In the photocurable ink composition for ink jet recording according to the invention, the metal or alloy layer can be made of aluminum or an aluminum alloy.

In the photocurable ink composition for ink jet recording according to the invention, the polymerizable compound can be a cationic polymerization compound.

In the photocurable ink composition for ink jet recording according to the invention, the polymerizable compound can be a radical polymerization compound.

The photocurable ink composition for ink jet recording according to the invention may further include a hindered amine compound.

In the photocurable ink composition for ink jet recording according to the invention, the metal or alloy layer of the metallic pigment may have an end face treated by chemical conversion.

### DESCRIPTION OF EXEMPLARY EMBODIMENTS

Preferred embodiments of the invention will be described in detail below.

### 1. Photocurable Ink Composition for Ink Jet Recording

The photocurable ink composition for ink jet recording according to the invention includes a metallic pigment, a polymerizable compound, and a polymerization initiator.

### 1.1. Metallic Pigment

The metallic pigment contained in the photocurable ink composition for ink jet recording according to this embodiment functions so as to impart metallic gloss to the adhering substance when the photocurable ink composition for ink jet recording adhered to a recording medium or the like.

The metallic pigment contained in the photocurable ink composition for ink jet recording of the embodiment is a composite pigment that is prepared by the following process.

The composite pigment of a first aspect is prepared by exfoliating a pigment layer from a composite pigment base substrate of the first aspect and pulverizing the pigment layer. The composite pigment base substrate of the first aspect has a structure in which the pigment layer is disposed on one or both surfaces of a sheet-like base material. The pigment layer of the composite pigment base substrate of the first aspect is composed of a silicon oxide layer, a metal or alloy layer, and a silicon oxide layer laminated in this order. This pigment layer is exfoliated from the sheet-like base material and pulverized to give the composite pigment of the first aspect.

The composite pigment of a second aspect is prepared by exfoliating a pigment layer from a composite pigment base substrate of the second aspect and pulverizing the pigment layer. The composite pigment base substrate of the second aspect has a structure in which the pigment layer is disposed on one or both surfaces of a sheet-like base material, as in the first aspect. The pigment layer of the composite pigment base substrate of the second aspect is a laminate of resin layer/metal or alloy layer/resin layer. This pigment layer is exfoliated from the sheet-like base material and pulverized to give the composite pigment of the second aspect.

Furthermore, the composite pigment of a third aspect includes a color material layer between the silicon oxide layer and the metal or alloy layer in the first aspect, and the composite pigment of a fourth aspect includes a color material layer between the resin layer and the metal or alloy layer in the second aspect. Each of these composite pigments also can be preferably used as the metallic pigment that is contained in the ink composition for ink jet recording of the embodiment.

The metallic pigment of the embodiment is any of the composite pigments described above and has a structure in which the metal or alloy layer is covered with the silicon oxide layers or the resin layers. Consequently, the metal or alloy layer is protected by the silicon oxide layers or the resin layers and thereby hardly discolors or fades, unlike known metallic pigments, to exhibit excellent storage stability. Furthermore, in the composite pigment including the resin layers in the laminate (the above-described second or fourth aspect), the resin layers can function as protective colloid. Therefore, a dispersion of such a composite pigment can be a metallic pigment dispersion exhibiting higher stability.

In addition, a desired color can be obtained by disposing a color material layer between the layers as in the composite pigments of the above-mentioned third and fourth aspects.

The metallic pigment of the embodiment is a laminate having a plate-like structure, as described above, and therefore exhibits excellent storage stability and dispersion stability in the photocurable ink composition for ink jet recording and also provides satisfactory ejection performance during the ink jet recording. Furthermore, the metallic pigment of the embodiment has a laminated sheet-like structure and thereby readily transmits light in the thickness direction, compared to typical pigments having spherical shapes. Therefore, light shielding is suppressed, which is significantly preferred in the photocurable ink composition for ink jet recording. In addition, since the mechanical strength is increased by employing the laminate structure, a decrease in metallic gloss due to deformation of the metallic pigment can be prevented.

The end face of the metallic pigment formed by pulverization has a portion where the metal or alloy layer is bared. Such a bared portion may be high in chemical activity and react with, for example, moisture or water vapor to corrode, resulting in occurrence of interfacial exfoliation. As a result, the metal or the alloy may be changed into, for example, a metal oxide or a metal hydroxide, which causes problems such as a decrease or lost of metallic gloss. Therefore, in order to avoid such problems, it is further preferred to form a chemically stable protection layer by subjecting the end face of the metallic pigment to chemical conversion treatment with a chemical oxidant.

Described below are the base substrate of the composite pigment of the embodiment, components of each layer constituting the composite pigment, the processes of forming the layers, and the processes of exfoliation and pulverization.

### Pigment Layer

First, the pigment layer in the laminated sheet-like structure of the composite pigment base substrate of the embodiment will be described.

The pigment layer of the composite pigment base substrate in the first aspect of the embodiment has a structure constituted by a silicon oxide layer, a metal or alloy layer, and a silicon oxide layer laminated in this order. The total thickness of the pigment layer is preferably in a range of 100 to 500 nm. A thickness smaller than 100 nm may cause insufficient mechanical strength, but a thickness larger than 500 nm may cause difficulties in pulverization and dispersion due to too high strength.

The metal or alloy layer in the pigment layer is not particularly limited as long as it has a function of providing metallic gloss or the like. For example, aluminum, silver, gold, nickel, chromium, tin, zinc, indium, and titanium are preferred, and at least one of these simple metals, their metal compounds or alloys, and mixtures thereof can be preferably used. Aluminum or an aluminum alloy is further preferred as the material for the metal or alloy layer of the pigment layer. The aluminum alloy may contain any element without limitation as the element other than aluminum as long as the aluminum alloy can exhibit metallic gloss. For example, the alloy element of aluminum may be at least one selected from silver, gold, platinum, nickel, chromium, tin, zinc, indium, titanium, and copper.

The metal or alloy layer may be formed by any method, without particular limitation, such as vacuum deposition, ion plating, or sputtering. The thickness of the metal or alloy layer is not particularly limited, but is preferably in a range of 15 to 150 nm. A thickness smaller than 15 nm may cause insufficient performance in, for example, reflectivity and brilliance as the metallic pigment, but a thickness larger than 150 nm may cause an increase in apparent specific gravity, resulting in a decrease in dispersion stability of the composite pigment. An unnecessary increase in the thickness of the metal or alloy layer merely leads to an increase in weight of the metallic pigment particles, and the reflectivity and brilliance are hardly increased by increasing the thickness of the layer to 150 nm or more.

The silicon oxide layer in the pigment layer is not particularly limited as long as it contains silicon oxide. The silicon oxide layer can be formed, for example, from a silicon alkoxide or a polymer thereof by a sol-gel method.

The silicon oxide layer can be formed by, for example, application of an alcohol solution dissolving the silicon alkoxide or its polymer to a target surface, followed by heating and baking. Specifically, the material for such a silicon oxide layer is available, for example, from Colcoat Co., Ltd. under model number “HAS-6”. In this case, the application of a material solution for the silicon oxide layer can be performed by a widely used method such as gravure coating, roll coating, blade coating, extrusion coating, dip coating, or spin coating. After the application and drying, if necessary, the surface may be smoothed by calender treatment.

The thickness of the silicon oxide layer is not particularly limited, but is preferably in a range of 50 to 150 nm. A thickness smaller than 50 nm may cause insufficient mechanical strength, but a thickness larger than 150 nm may cause difficulties in pulverization and dispersion due to too high strength and further cause exfoliation at the interface with the metal or alloy layer.

In the second aspect of the embodiment, the pigment layer of the composite pigment base substrate has a structure constituted by a resin layer, a metal or alloy layer, and a resin layer laminated in this order. The metal or alloy layer is the same as that of the composite pigment base substrate in the first aspect, and therefore the description thereof is omitted.

The resin layer in the pigment layer of the composite pigment base substrate of the second aspect is not particularly limited, but can be constituted by, for example, a polymer such as polyvinyl alcohol, polyalkylene glycol, polyacrylic acid, or polyacryl amide; a cellulose derivative such as hydroxypropyl cellulose, carboxymethyl cellulose, or cellulose acetate butyrate; polyvinyl acetal, polyvinyl butyral, an acrylic acid copolymer, or a denatured nylon resin. In the case that the resin layer is in contact with a surface of a sheet-like base material described below, the material constituting the resin layer is more preferably a material that is exfoliative from the sheet-like base material.

In the pigment layer of the composite pigment base substrate of the second aspect, the thickness of the resin layer is not particularly limited, but is preferably 0.5 to 50 μm and more preferably 1 to 10 μm. A thickness smaller than 0.5 μm may be insufficient for exhibiting a function of protecting the metal or alloy layer or may be insufficient for exhibiting a function as a dispersion resin to impart satisfactory dispersion stability to the ink composition. Conversely, when the thickness of the resin layer in the pigment layer of the composite pigment base substrate of the second aspect is larger than 50 μm, the resin layer may be readily exfoliated at the interface with the metal or alloy layer, when the base substrate is rolled up.

The resin layer in the composite pigment base substrate of the second aspect can be formed by, for example, applying a solution dissolving the above-mentioned resin in a suitable solvent to a target surface, followed by drying. In this case, the application of the solution for the resin layer can be performed by a widely used method such as gravure coating, roll coating, blade coating, extrusion coating, dip coating, or spin coating. After the application and drying, if necessary, the surface may be smoothed by calender treatment to obtain glossiness.

In the third and fourth aspects of the embodiment, the pigment layer of the composite pigment base substrate has a structure including a color material layer between the metal or alloy layer and the silicon oxide layer or the resin layer. That is, in the composite pigments in the third and fourth aspects of the embodiment, at least one color material layer is disposed so as to be adjacent to the metal or alloy layer in the pigment layer.

The color material layer has a function of imparting arbitrary color tone and tint to the composite pigment of the embodiment, in addition to metallic gloss and brilliance originated from the metal and alloy layer. The color material contained in the color material layer is not particularly limited, and widely known dyes and pigments can be preferably used. In addition, the color material layer may contain a polymer dispersant, such as a polyvinyl butyral resin or a cellulose resin (for example, cellulose acetate butyrate, carboxymethyl cellulose, or hydroxypropyl cellulose), as the dispersant of the solution or dispersion of the color material. The color material layer may be formed by any method without particular limitation and, for example, can be formed by coating a target surface with a solution or dispersion of a color material. In this case, the coating can be performed by a widely used method such as gravure coating, roll coating, blade coating, extrusion coating, dip coating, or spin coating. After the coating and drying, if necessary, the surface may be smoothed by calender treatment to obtain glossiness.

The bared portion of the metal or alloy layer generated at the end face of the metallic pigment by pulverizing the metallic pigment is preferably formed into a chemically stable protection layer by chemical conversion treatment with a chemical oxidant. Preferred examples of the chemical oxidant used in such a case include nonvolatile organic acids such as hydrogen peroxide, chromic acid, phosphoric acid, phosphate, citric acid, and malic acid.

The composite pigment in each of the first to fourth aspects of the embodiment may have a repeated laminate structure.

### Sheet-Like Base Material

The sheet-like base material used in the composite pigment base substrate of the embodiment is not particularly limited, and examples thereof include release films, for example, polyester films such as polytetrafluoroethylene, polyethylene, polypropylene, polyethylene terephthalate, and polyethylene naphthalate; polyamide films such as Nylon 66 and Nylon 6; polycarbonate films, triacetate films, and polyimide films. Among them, particularly preferred sheet-like base materials are polyethylene terephthalate and copolymers thereof.

The thickness of the sheet-like base material is not particularly limited, but is preferably 10 to 150 μm. A thickness of 10 μm or more exhibits satisfactory qualities for handling in steps and the like, and a thickness of 150 μm or less provides flexibility and hardly causes problems in, for example, rolling and exfoliation treatment.

### Exfoliation Layer

An exfoliation layer may be provided on one or both surfaces of the sheet-like base material used in the composite pigment base substrate of the embodiment. The pigment layer can be more readily exfoliated from the sheet-like base material by providing the exfoliation layer. The exfoliation layer is not particularly limited, but, for example, a polyvinyl alcohol resin, a polyvinyl butyral resin, or a cellulose resin such as cellulose acetate butyrate, carboxymethyl cellulose, or hydroxypropyl cellulose can be used. When the exfoliation layer is provided in the composite pigment base substrate of the second or fourth aspect, the material constituting the exfoliation layer and the material constituting the resin layer are preferably different from each other at least in solubility to a specific solvent.

### Exfoliation and Pulverization of Composite Pigment

The composite pigment of the embodiment is obtained by exfoliating the pigment layer of the composite pigment base substrate from the sheet-like base material and finely pulverizing the pigment layer.

The method for exfoliation treatment of the composite pigment is not particularly limited. For example, the composite pigment is exfoliated by immersing the composite pigment base substrate in a liquid. Furthermore, for example, the composite pigment base substrate immersed in a liquid may be sonicated for simultaneously performing exfoliation and pulverization of the exfoliated pigment layer. The exfoliated pigment layer may be mechanically pulverized. Furthermore, a desired particle size distribution can be obtained by sorting and collecting the composite pigment having an objective particle size from the pulverized pigment layer.

The metallic pigment (composite pigment) of the embodiment described above further has the following features. The metallic pigment having the above-described laminate structure has a plate-like particle shape. The term “plate-like particle” refers to a particle having a flat plate-like shape having an approximately flat surface (X-Y plane) and an approximately uniform thickness (Z), wherein the plate thickness Z is smaller than the size in the plate surface direction (size on the X-Y plane) of the plate-like particle. In the specification, as parameters of the shape of a plate-like particle, the major axis and the minor axis of a flat surface (plate surface direction) of the plate-like particle are defined as X and Y, respectively, and the thickness of the plate-like particle is defined as Z.

The metallic pigment having such a plate-like shape is easily arranged in such a manner that the normal-line direction of a recording medium and the thickness direction of the metallic pigment are the same when the photocurable ink composition for ink jet recording adheres to the recording medium. Therefore, the amount of the metallic pigment necessary for forming a glossy metallic surface on the recording medium can be reduced. In addition, since the metallic pigment is plate-like, the printed surface readily transmits light when irradiated with the light. Consequently, the printed surface of the photocurable ink composition can be readily cured.

In order to increase the metallic gloss of a printed surface formed on a recording medium and further reduce the amount of light necessary for curing the printed surface, the metallic pigment particle preferably has a shape having a major axis X, a minor axis Y, and a thickness Z satisfying the requirements that the 50% average particle diameter R50 based on a circle-equivalent diameter determined from the X-Y plane area is 0.5 to 3 μm and R50/Z>5.

Here, the term “circle-equivalent diameter” refers to the diameter of a circle having the same area as that of the X-Y plane of the plate-like particle projected in the Z direction. The circle-equivalent diameter can be measured with, for example, a particle image analyzer (for example, FPIA-2100, FPIA-3000, or FPIA-3000S, manufactured by Sysmex Corp.) or image analysis of microscopic observation results.

The 50% average particle diameter R50 of the circle-equivalent diameters of plate-like particles refers to the circle-equivalent diameter at the 50% point of the total number of the measured particles in a number (frequency) distribution of the particles drawn with respect to the circle-equivalent diameters.

By doing so, the surface flatness of the printed surface formed on a recording medium can be enhanced, and the metallic glossiness of the printed surface can be also enhanced. Furthermore, since the amount of light passing through the metallic pigment can be increased, the light dose necessary for curing the printed surface can be decreased.

The metallic pigment produced by the above-described method can be characterized by the properties of the deposited metal film formed in the production process. That is, the light transmittance of the metal or metal compound layer prepared in the process of producing the metallic pigment can be easily measured. In addition, it is believed that the metallic pigment obtained by pulverizing this layer has the same light transmittance as that of the metal or alloy layer. The light transmittance of the metal or alloy layer can be measured with, for example, a accumulated UV meter, C9536/H9535 series, manufactured by Hamamatsu Photonics K.K. or a UV radiometer, UM-10, manufactured by Konica Minolta Holdings, Inc.

In the metallic pigment of the invention, in order to reduce the amount of light necessary for curing the printed surface formed on a recording medium, the transmittance of light, in particular, the transmittance of light having a wavelength of approximately 350 to 450 nm, which is used in curing treatment, in the thickness direction of the metal or alloy layer is further preferably 0.5% or more.

The maximum particle diameter Rmax based on a circle-equivalent diameters determined from the X-Y plane areas of the plate-like particles of the metallic pigment is preferably 10 μm or less from the viewpoint of preventing clogging of a nozzle when the photocurable ink composition for ink jet recording is applied with an ink jet recording apparatus.

The metallic pigment content in the photocurable ink composition for ink jet recording is preferably 0.1 to 2 mass % and more preferably 0.5 to 1.75 mass %. When the content is less than this range, insufficient metallic gloss may be provided on the printed surface. When the content is higher than this range, the hardening properties of the printed surface may be deteriorated.

### 1.2. Polymerizable Compound

Examples of the polymerizable compound contained in the photocurable ink composition for ink jet recording of the embodiment include monofunctional polymerizable compounds and polyfunctional polymerizable compounds. These polymerizable compounds are not particularly limited as long as polymerization is initiated by being supplied with any kind of energy to cure, and every form of a monomer, an oligomer, a linear polymer, and a dendritic polymer can be used.

Examples of the radical polymerization compound that can be used in the photocurable ink composition for ink jet recording include (meth)acrylates, (meth)acrylamides, aromatic vinyls, allyl compounds, N-vinyl compounds, vinyl esters (for example, vinyl acetate, vinyl propionate, and vinyl versatate), allyl esters (for example, allyl acetate), halogen-containing monomers (for example, vinylidene chloride and vinyl chloride), vinyl ethers (for example, methyl vinyl ether, butyl vinyl ether, hexyl vinyl ether, methoxy vinyl ether, 2-ethylhexyl vinyl ether, methoxyethyl vinyl ether, cyclohexyl vinyl ether, and chloroethyl vinyl ether), vinyl cyanides (for example, (meth)acrylonitrile), and olefins (for example, ethylene and propylene). In the specification, “(meth)acrylate” refers to one or both of “acrylate” and “methacrylate”, and “(meth)acryl” refers to one or both of “acryl” and “methacryl”, depending on cases.

In the embodiment, common monofunctional (meth)acrylates and polyfunctional (meth)acrylates can be preferably used as the (meth)acrylates. Among the (meth)acrylates, typical polyfunctional (meth)acrylate is, for example, a compound having a plurality of (meth)acryloyl groups in the molecule, and a linear polymer having a plurality of (meth)acryloyl groups and a dendritic polymer having a plurality of (meth)acryloyl groups can be preferably used. In particular, the dendritic polymer having a plurality of (meth)acryloyl groups is preferred in the embodiment, and, specifically, such a compound is available, for example, from Osaka Organic Chemical Industry Ltd. under a trade name of “Viscoat #1000”. This compound is a hyperbranched polymer synthesized by adding functional groups as branches to dipentaerythritol as a core. Since the density of acryloyl groups is high near the surface of the polymer molecule, the polymer compound is preferably used as a polymerizable compound.

Examples of the (meth)acrylamides include (meth)acrylamide, N-methyl(meth)acrylamide, N-ethyl(meth)acrylamide, N-propyl(meth)acrylamide, N-n-butyl(meth)acrylamide, N-t-butyl(meth)acrylamide, N-butoxymethyl(meth)acrylamide, N-isopropyl(meth)acrylamide, N-methylol(meth)acrylamide, N,N-dimethyl(meth)acrylamide, N,N-diethyl(meth)acrylamide, and (meth)acryloyl morpholine.

Examples of the aromatic vinyls include styrene, methylstyrene, trimethylstyrene, ethylstyrene, isopropylstyrene, chloromethylstyrene, methoxystyrene, acetoxystyrene, chlorostyrene, dichlorostyrene, bromostyrene, methyl vinyl benzoate, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene, and 4-t-butoxystyrene.

The allyl compound has a 2-propenyl structure (—CH₂CH═CH₂). The 2-propenyl group is also called an allyl group and is regarded as a trivial name, which is endorsed by the IUPAC nomenclature. Examples of the allyl compound include ethylene glycol monoallyl ether, allyl glycol (available, for example, from Nippon Nyukazai Co., Ltd.), trimethylolpropane diallyl ether, pentaerythritol triallyl ether, glycerin monoallyl ether (these are available from, for example, Daiso Co., Ltd.), and polyoxyalkylene compounds having allyl groups, which are available under trade names of Uniox, Unilub, Polycerin, and Unisafe from NOF Corp.

The N-vinyl compound has a structure in which a vinyl group is bonded to a nitrogen atom (>N—CH═CH₂). The N-vinyl compound has radical polymerizability. Examples of the N-vinyl compound include N-vinyl formamide, N-vinyl carbazole, N-vinyl indole, N-vinyl pyrrole, N-vinyl acetamide, N-vinyl pyrrolidone, N-vinyl caprolactam, and derivatives thereof. Among these compounds, N-vinyl formamide is particularly preferred. N-vinyl formamide is available from, for example, Arakawa Chemical Industries, Ltd.

Among the polymerizable compounds, compounds including functional groups having active hydrogen readily generate radicals and are therefore further preferred to enhance polymerizability. In addition, these compounds are hardly affected by oxygen inhibition. Consequently, they can be cured by relatively low energy and are therefore further preferred. Examples of the functional groups having active hydrogen include amino groups, imino groups, and alcoholic hydroxyl groups. It is further preferred that the photocurable ink composition for ink jet recording contain a polymerizable compound having such a group described above. In addition, a thiol group may be contained instead of the alcoholic hydroxyl group. Examples of the compound including a functional group having active hydrogen include N-vinyl formamide, urethane-based oligomers (for example, available from Shin-nakamura Chemical Co., Ltd. under trade names of U-4HA and U-15HA), ethylene glycol monoallyl ether, diethylene glycol monoallyl ether, trimethylolpropane diallyl ether, trimethylolpropane monoallyl ether, glycerin monoallyl ether, allyl glycidyl ether, pentaerythritol triallyl ether, hydroxybutyl vinyl ether, 2-hydroxyethyl(meth)acrylate, 2-hydroxypropyl(meth)acrylate, 4-hydroxybutyl(meth)acrylate, alkanethiol, and alkylenethiol.

Furthermore, among the polymerizable compounds, compounds including functional groups having ethylene unsaturated double bonds are highly polymerizable and are therefore further preferred to enhance the curing rate and the curing properties of a printed surface. In addition, these compounds are hardly affected by oxygen inhibition. Consequently, they can be cured by relatively low energy and are therefore further preferred. Examples of the functional groups having the ethylene unsaturated double bonds include vinyl groups and allyl groups, such as the above-mentioned allyl compounds and vinyl compounds.

Examples of the cationic polymerizable compound include epoxy compounds, vinyl ether compounds, oxetane compounds, and oxirane compounds.

Examples of the epoxy compounds include aromatic epoxides and alicyclic epoxides.

Examples of the monofunctional epoxy compounds include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monoxide 1,2-epoxydodecane, epichlorohydrin, 1,2-epoxydecane, styrene oxide, cyclohexene oxide, 3-methacryloyloxymethyl cyclohexene oxide, 3-acryloyloxymethyl cyclohexene oxide, and 3-vinylcyclohexene oxide.

Examples of the polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxycyclohexyl-5,5-spiro-3,4-epoxy)cyclohexane-metha-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, di(3,4-epoxycyclohexylmethyl)ether of ethylene glycol, ethylenebis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, and 1,2,5,6-diepoxycyclooctane.

Among these epoxy compounds, aromatic epoxides and alicyclic epoxides are preferred from the viewpoint of the high curing rate, and the alicyclic epoxides are particularly preferred.

Examples of the monofunctional vinyl ethers that can be used in the embodiment include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxy polyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenyl ethyl vinyl ether, and phenoxy polyethylene glycol vinyl ether.

Examples of the polyfunctional vinyl ether include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and other polyfunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, ethylene oxide-added trimethylolpropane trivinyl ether, propylene oxide-added trimethylolpropane trivinyl ether, ethylene oxide-added ditrimethylolpropane tetravinyl ether, propylene oxide-added ditrimethylolpropane tetravinyl ether, ethylene oxide-added pentaerythritol tetravinyl ether, propylene oxide-added pentaerythritol tetravinyl ether, ethylene oxide-added dipentaerythritol hexavinyl ether, and propylene oxide-added dipentaerythritol hexavinyl ether.

Preferred vinyl ether compounds are di- or tri-vinyl ether compounds from the viewpoints of, for example, curing properties, adhesion to a recording medium, and surface hardness of a formed image. Divinyl ether compounds are particularly preferred.

The oxetane compounds that can be used in the embodiment are compounds having oxetane rings, and, as described in JP-A-2001-220526, JP-A-2001-310937, and JP-A-2003-341217, a known oxetane compound can be arbitrarily used.

Compounds having oxetane rings that can be used for the ink composition of the embodiment preferably have one to four oxetane rings in its structure. By using such a compound, the viscosity of the ink composition can be readily maintained within the range that provides excellent handling ability, and also the adhesion of the cured ink to a recording medium can be enhanced.

Examples of the monofunctional oxetane used in the embodiment include 3-ethyl-3-hydroxymethyloxetane, 3-(meth)allyloxymethyl-3-ethyloxetane, 3-ethyl-3-(2-ethylhexyloxymethyl)oxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobornyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyl diethylene glycol (3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, and bornyl(3-ethyl-3-oxetanylmethyl)ether.

Examples of the polyfunctional oxetane include 3,7-bis(3-oxetanyl)-5-oxa-nonane, 3,3′-[1,3-(2-methylenyl)propanediylbis(oxymethylene)]bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenylbis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropanetris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, EO-modified bisphenol A bis(3-ethyl-3-oxetanylmethyl)ether, PO-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, and EO-modified bisphenol F (3-ethyl-3-oxetanylmethyl)ether.

Among the oxetane compounds used in the embodiment, a compound having one or two oxetane rings are preferred from the viewpoints of the viscosity and the adhesion of the ink composition.

In the photocurable ink composition for ink jet recording of the embodiment, these polymerizable compounds may be used alone or in a combination of two or more thereof, but, from the viewpoint of effectively suppressing shrinkage during ink curing, a combination of at least one oxetane compound and at least one compound selected from the epoxy compounds and the vinyl ether compounds is preferred.

Furthermore, in addition to the above-mentioned polymerizable compounds, known polymerizable compounds can be used. For example, the polymerizable compounds disclosed in JP-A-2008-138166, JP-A-2007-120991, and JP-A-2008-88228 can be also used.

The content of the polymerizable compound in the photocurable ink composition for ink jet recording in the embodiment is appropriately 50 to 95 mass %, preferably 60 to 92 mass %, and more preferably 70 to 90 mass % with respect to the total amount of the composition.

### 1.3. Polymerization Initiator

The photocurable ink composition for ink jet recording according to the embodiment contains a polymerization initiator. The polymerization initiator contained in the photocurable ink composition for ink jet recording can generate active species by light. Examples of the light for generating active species of the polymerization initiator include ultraviolet light in the range of 200 to 400 nm, visible light, far-ultraviolet light, g rays, h rays, i rays, KrF excimer laser light, ArF excimer laser light, and electromagnetic rays such as X-rays.

Examples of the polymerization initiator contained in the photocurable ink composition for ink jet recording include aromatic ketones, aromatic onium salt compounds, organic peroxides, hexaaryl biimidazole compounds, ketoxime ester compounds, borate compounds, azinium compounds, metallocene compounds, active ester compounds, and compounds having carbon-halogen bonds.

In addition to the above-mentioned polymerization initiator, known polymerization initiators, for example, those disclosed in JP-A-2008-138166, JP-A-2007-120991, and JP-A-2008-88228, can be used.

Examples of the polymerization initiator include benzyl dimethyl ketal, α-hydroxyalkylphenone, α-aminoalkylphenone, acylphosphine oxide, oxime ester, thioxanthone, α-dicarbonyl, anthraquinone, and those available under trade names of Vicure 10, 30 (manufactured by Stauffer Chemical Company), Irgacure 127, 184, 500, 651, 2959, 907, 369, 379, 754, 1700, 1800, 1870, 819, OXE01, Darocur 1173, TPO, and ITX (manufactured by Ciba Specialty Chemicals Inc.), Quantacure CTX (manufactured by Aceto Chemical Corp.), Kayacure and DETX-S (manufactured by Nippon Kayaku Co., Ltd.), ESACURE KIP150 (manufactured by Lamberti Co.), and Cyracure UVI-6692 and Cyracure UVR-6105 (manufactured by The Dow Chemical Company).

### 1.4. Other Components

The photocurable ink composition for ink jet recording of the embodiment may further contain, in addition to the above-described polymerizable compound and polymerization initiator, for example, a color material, a polymerization enhancer, a thermal radical polymerization inhibitor, a surfactant, a wetting agent, a permeation solvent, a pH-adjusting agent, an antiseptic agent, and a fungicide. Furthermore, according to need, the ink composition may contain a leveling additive agent, a mat agent, and an agent for adjusting physical properties of the recorded matter, such as a polyester resin, a polyurethane resin, a vinyl resin, an acrylic resin, a rubber resin, or wax.

The color material contained in the photocurable ink composition for ink jet recording may be either a dye or a pigment. Examples of the dye include various dyes that are widely used in ink jet recording, such as direct dyes, acid dyes, food dyes, basic dyes, reactive dyes, disperse dyes, vat dyes, and soluble vat dyes.

The pigment is not particularly limited, and examples thereof include inorganic pigments and organic pigments. As the inorganic pigment, in addition to titanium oxide and iron oxide, carbon black produced by a known method such as a contact method, a furnace method, or a thermal method can be used. As the organic pigment, for example, azo pigments (including azolake, insoluble azo pigments, condensed azo pigments, and chelate azo pigments), polycyclic pigments (for example, phthalocyanine pigments, perylene pigments, perinone pigments, anthraquinone pigments, and quinoflarone pigments), dye chelates (for example, basic dye chelates and acid dye chelates), nitro pigments, nitroso pigments, and aniline black can be used. Among these color materials, the dyes hardly block light necessary for photocuring the polymerizable compound, and are therefore more preferred.

The amount of the color material added to the photocurable ink composition for ink jet recording is preferably 0.1 to 25 mass % and more preferably 0.5 to 15 mass %.

The average particle diameter of the dye contained in the photocurable ink composition for ink jet recording is preferably in a range of 10 to 200 nm and more preferably in a range of 50 to 150 nm.

In the photocurable ink composition for ink jet recording containing a pigment, the ink composition may contain a dispersant or a surfactant for obtaining a satisfactory dispersion of the pigment. Dispersants that are widely used for preparing pigment dispersions, for example, polymer dispersants, can be preferably used. An example of the polymer dispersant is a polyoxyalkylene-polyalkylene-polyamine. Examples of the polyoxyalkylene-polyalkylene-polyamine include Discole N-503, N-506, N-509, N-512, N-515, N-518, and N-520 (manufactured by Dai-ichi Kogyo Seiyaku Co., Ltd.).

By adding the color material described above to the photocurable ink composition for ink jet recording, the glossy metallic surface can be colored to enhance the power of expression of the recorded matter.

The photocurable ink composition for ink jet recording may further contain a polymerization enhancer. The polymerization enhancer that can be contained in the photocurable ink composition for ink jet recording is not particularly limited, but, for example, Darocur EHA and EDB (available from Ciba Specialty Chemicals Inc.) can be used.

Furthermore, the photocurable ink composition for ink jet recording may contain a hindered amine compound as the thermal radical polymerization inhibitor. The photocurable ink composition for ink jet recording containing the hindered amine compound is enhanced in the storage stability. Particularly preferred hindered amine compounds are compounds having a 2,2,6,6-tetramethylpiperidine group in its structure. Examples of such hindered amine compounds include 2,2,6,6-tetramethylpiperidinoxy free radical and bis(1-octyloxy-2,2,6,6-tetramethyl-4-piperidyl)sebacate. A commercially available compound having a 2,2,6,6-tetramethylpiperidine group in its structure is, for example, Irgastab UV-10 (available from Ciba Specialty Chemicals Inc.). The amount of the thermal radical polymerization inhibitor blended in the photocurable ink composition for ink jet recording is preferably 0.01 to 1 mass % and more preferably 0.05 to 0.5 mass %.

Furthermore, the photocurable ink composition for ink jet recording may contain a surfactant for enhancing the storage stability or the like. The surfactant can be a silicone surfactant such as polyester-modified silicone or polyether-modified silicone, and polyether-modified polydimethylsiloxane and polyester-modified polydimethylsiloxane are particularly preferred. Examples thereof include BYK-347, BYK-348, BYK-UV3500, -UV3510, -UV3530, and -UV3570 (available from BYK Chemie Japan K.K.).

The viscosity of the photocurable ink composition for ink jet recording can be controlled by controlling the amount of each component described above. The photocurable ink composition for ink jet recording can have a viscosity suitable for being applied to an ink jet recording apparatus by controlling the viscosity thereof. The viscosity of the photocurable ink composition for ink jet recording is preferably in a range of 2.0 to 20 (mPa·s) at 20° C. An ink composition having a viscosity deviating from this range may be hardly ejected by the ink jet recording apparatus.

The above-described photocurable ink composition for ink jet recording of the embodiment includes a metallic pigment composed of plate-like particles in which the metal or alloy layer and at least one selected from the resin layer and the silicon oxide layer are laminated. Therefore, the plate-like particles are arranged on a recording medium in such a manner that the normal-line direction of the recording medium and the normal-line direction of the plate-like particles are the same. Consequently, a printed surface having a glossy metallic surface with high glossiness can be formed on the recording medium. Furthermore, since the photocurable ink composition for ink jet recording of the embodiment includes the metallic pigment composed of plate-like particles, photopolymerization of the polymerizable compound in the printed surface can sufficiently proceed. Hence, the photocurable ink composition for ink jet recording of the embodiment can be preferably applied to an ink jet recording method.

### 2. Ink Jet Recording Method

In an example of the ink jet recording method according to the embodiment, the above-described photocurable ink composition for ink jet recording is ejected such that the ink composition adhere to a recording medium to form a printed surface on the recording medium, and then the printed surface is irradiated with ultraviolet rays as light.

In the ink jet recording method according to the embodiment, the photocurable ink composition for ink jet recording is ejected on a recording medium with an ink jet recording apparatus. The ink jet recording apparatus used in the embodiment is not particularly limited as long as it can eject ink droplets so that the droplets adhere to a recording medium for recording information.

The recording system of the ink jet recording apparatus is, for example, a system in which a strong electric field is applied between a nozzle and an acceleration electrode disposed ahead of the nozzle to sequentially eject ink droplets from the nozzle and a printing information signal is applied to a deflection electrode, for recording, while the ink droplets are traveling between the deflection electrodes; a system (electrostatic attraction system) in which ink droplets are ejected according to printing information signals without deflecting the ink droplets; a system in which an ink solution is applied with a pressure by a small-sized pump and a nozzle is mechanically vibrated using a quartz oscillator or the like to forcedly eject the ink droplets; a system (piezoelectric system) in which a piezoelectric element simultaneously applies a pressure and a printing information signal to an ink solution to eject ink droplets for recording; or a system (thermal jet system) in which an ink solution is heated with a microelectrode according to a printing information signal to form foam for ejecting ink droplets for recording.

The ink jet recording apparatus includes an ink jet recording head, a body, a tray, a head-driving mechanism, a carriage, an ultraviolet irradiation unit mounted on a side face of the carriage, and so on. The ink jet recoding head includes at least four ink cartridges for cyan, magenta, yellow, and black and is configured so as to be capable of full color printing. At least one of these ink cartridges is filled with the photocurable ink composition for ink jet recording according to the embodiment, and the cartridges are set. In addition, the ink jet recording apparatus is provided with, for example, an exclusive control board in the inside thereof for controlling the ink ejection timing of the ink jet recording head and scanning of the head-driving mechanism.

The ultraviolet irradiation can be conducted by the ultraviolet irradiation unit mounted on the side face of the carriage in the ink jet recording apparatus. The wavelength of the irradiation light is not particularly limited, but is preferably from 350 nm to 450 nm. The light dose is preferably in a range of from 10 mJ/cm² to 20000 mJ/cm² and more preferably from 50 mJ/cm² to 15000 mJ/cm². Ultraviolet light in this dose range can sufficiently cure the printed surface of the photocurable ink composition for ink jet recording formed on a recording medium.

In addition, ultraviolet irradiation may be performed by inducing light to the printed surface with a light guide from a metal halide lamp, a xenon lamp, a carbon arc lamp, a chemical lamp, a low-pressure mercury lamp, a high-pressure mercury lamp, or the like. The light source may be, for example, a commercially available lamp such as H lamp, D lamp, or V lamp available from Fusion System can be used. Furthermore, an ultraviolet light-emitting semiconductor element such as an ultraviolet light-emitting diode (ultraviolet LED) or an ultraviolet light-emitting semiconductor laser can be used as a light source for conducting ultraviolet irradiation.

The ultraviolet irradiation may be performed inside the ink jet recording apparatus as in those exemplarily shown above or may be performed using an external ultraviolet irradiation unit after formation of a printed surface with an ink jet recording apparatus that does not have the ultraviolet irradiation unit.

Any recording medium can be used in the ink jet recording method of the embodiment as long as the ink composition can adhere thereon by using an ink jet recording apparatus. Examples of the recording medium include nonabsorptive recording media such as metal, glass, and plastic and absorptive recording media such as paper, film, and cloth. In addition, the recording medium may be, for example, colorless transparent, translucent, colored transparent, chromatic opaque, or achromatic opaque.

The ink jet recording method of the embodiment can be applied to a production of a color filter or a process for manufacturing industrial products, such as marking to a printing substrate.

In the ink jet recording method such as the above, since the photocurable ink composition for ink jet recording contains a metallic pigment composed of a plate-like particle, a printed surface having a glossy metallic surface with high glossiness can be formed on a recording medium. Furthermore, since the photocurable ink composition for ink jet recording contains a metallic pigment composed of a plate-like particle, curing reaction of the polymerizable compound in the printed surface can sufficiently proceed.

### 3. Recorded Matter

The recorded matter obtained by the ink jet recording method of the embodiment is formed by using the above-described photocurable ink composition for ink jet recording and therefore has a glossy metallic surface with high glossiness. Furthermore, since the photocurable ink composition for ink jet recording contains a metallic pigment composed of a plate-like particle, curing reaction of the polymerizable compound in the printed surface sufficiently proceeds.

### 4. Ink Set

An exemplary ink set according to the embodiment includes at least one ink containing the above-described photocurable ink composition for ink jet recording.

The ink set may include inks containing the photocurable ink composition for ink jet recording alone or in a combination. In addition, the ink set may include one or more other ink compositions. Examples of the other ink compositions included in the ink set for ink jet recording include color ink compositions of, for example, cyan, magenta, yellow, light cyan, light magenta, dark yellow, red, green, blue, orange, and violet; black ink compositions; and light black ink compositions.

### 5. Ink Cartridge and Ink Jet Recording Apparatus

An exemplary ink cartridge according to the embodiment is provided with the ink set described above. With the cartridge, the ink set including the photocurable ink composition for ink jet recording can be readily carried. The ink jet recording apparatus according to the embodiment includes the photocurable ink composition for ink jet recording and the ink set or ink cartridge for ink jet recording, and an example of the ink jet recording apparatus is that described in the section of the ink jet recording method.

### 6. Example and Comparative Example

The invention will be more specifically described with reference to examples, but the scope of the invention is not to be limited thereby.

### 6.1. Examples

### 6.1.1. Preparation of Composite Pigment A and Undiluted Dispersion of Composite Pigment A

### 6.1.1.1. Formation of Exfoliation Layer

The following coating liquid was applied onto a PET film with a thickness of 100 μm by spin coating, followed by drying to form an exfoliation layer.

### Exfoliation Layer Coating Liquid

A solution of ion-exchanged water dissolving 3.3 mass % of PVA (polyvinyl alcohol, average molecular weight: 10000, degree of saponification: 80%) and 1.7 mass % of glycerin was used as the exfoliation layer coating liquid.

### Exfoliation Layer Coating Condition

The exfoliation layer coating liquid was coated on the PET film by spin coating. The coating was carried out under conditions that the exfoliation layer coating liquid was dropwise applied onto the PET film on a turntable, and the turntable was rotated at 500 rpm for 5 seconds and then at 2000 rpm for 30 seconds, followed by drying at 100° C. for 5 minutes. The exfoliation layer formed under such conditions had a thickness of 10 μm.

### 6.1.1.2. Formation of Pigment Layer

### Formation of Silicon Oxide Layer

The following coating liquid was applied by spin coating onto the exfoliation layer formed by the above-described process on a surface of the PET film, followed by baking to form a silicon oxide layer.

### Silicon Oxide Layer Coating Liquid

A mixture of 10 mass % of HAS-6 (manufactured by Colcoat Co., Ltd.), 42.5 mass % of ethanol, and 47.5 mass % of 2-ethoxyethanol was used as the silicon oxide layer coating liquid.

Silicon oxide layer coating condition

The silicon oxide layer coating liquid was coated by spin coating on the exfoliation layer formed on the PET film. The coating was carried out under conditions that the silicon oxide layer coating liquid was dropwise applied onto the exfoliation layer on the PET film on a turntable, and the turntable was rotated at 500 rpm for 5 seconds and then at 2000 rpm for 30 seconds, followed by baking at 140° C. for 5 minutes. The silicon oxide layer formed under such conditions had a thickness of 70 nm.

### Formation of Color Material Layer

### Color Material Layer Coating Liquid

A color material layer coating liquid was prepared. Ion-exchanged water containing 15.0 mass % of C.I. pigment yellow 110 (color material) as a color material, 5.0 mass % of a styrene-acrylic acid copolymer ammonium salt (molecular weight: 10000) as a dispersant, and 5.0 mass % of glycerin was used as the color material layer coating liquid.

The color material layer coating liquid was prepared by dispersing a mixture of the color material, the dispersant, glycerin, and ion-exchanged water in a sand mill (manufactured by Yasukawa Seisakusyo K.K.) with glass beads (diameter: 1.7 mm, an amount of 1.5 times (by weight) the weight of the mixture) for 2 hours and then removing the glass beads.

### Color Material Layer Coating Condition

The thus prepared color material layer coating liquid was applied onto the silicon oxide layer by spin coating, followed by drying to form a color material layer having a thickness of 150 nm.

### Formation of Aluminum Layer

An aluminum layer having a thickness of 70 nm was formed by depositing aluminum on the color material layer using a vacuum deposition device, model VE-1010, manufactured by Vacuum Device Inc.

### Formation of Color Material Layer

As in the formation of the color material layer described above, a color material layer was formed on the aluminum layer. The thickness of the resulting color material layer was also 150 nm.

### Formation of Silicon Oxide Layer

As in the formation of the silicon oxide layer described above, a silicon oxide layer was formed on the color material layer. The thickness of the resulting silicon oxide layer was 70 nm.

### 6.1.1.3. Properties of Base Substrate of Composite Pigment A

As in above, a base substrate of composite pigment A having a structure including an exfoliation layer and a pigment layer (silicon oxide layer/color material layer/aluminum layer/color material layer/silicon oxide layer) on a sheet-like base material was produced. It was confirmed by visual inspection that the base substrate of the composite pigment A was golden colored.

### 6.1.1.4. Exfoliation, Pulverization, and Dispersion

The PET film thus provided with a laminate of exfoliation layer/silicon oxide layer/color material layer/aluminum layer/color material layer/silicon oxide layer was simultaneously subjected to exfoliation, miniaturization, and dispersion treatment in ethylene glycol monoallyl ether using an ultrasonic disperser.

As described above, the composite pigment A and undiluted dispersion containing the composite pigment A were prepared. The composite pigment A corresponds to the composite pigment of the third aspect described in the embodiment section.

### 6.1.2. Preparation of Composite Pigment B and Undiluted Dispersion of Composite Pigment B

### 6.1.2.1. Formation of Exfoliation Layer

The following coating liquid was applied onto a PET film with a thickness of 100 μm by spin coating, followed by drying to form an exfoliation layer.

### Exfoliation Layer Coating Liquid

A solution of IPA (isopropyl alcohol) dissolving 3.3 mass % of S-LEC BL-10 (butyral resin manufactured by Sekisui Chemical Co., Ltd.) and 2.0 mass % of glycerin was used as the exfoliation layer coating liquid.

### Exfoliation Layer Coating Condition

The exfoliation layer coating liquid was coated on the PET film by spin coating. The coating was carried out under conditions that the exfoliation layer coating liquid was dropwise applied onto the PET film on a turntable, and the turntable was rotated at 500 rpm for 5 seconds and then at 2000 rpm for 30 seconds, followed by drying at 100° C. for 5 minutes. The exfoliation layer formed under such conditions had a thickness of 10 μm.

### 6.1.2.2. Formation of Pigment Layer

### Formation of Resin Layer

The following coating liquid was applied by spin coating onto the exfoliation layer formed by the above-described process on a surface of the PET film, followed by drying to form a resin layer.

### Resin Layer Coating Liquid

A solution of ion-exchanged water dissolving 3.3 mass % of PVA (polyvinyl alcohol, average molecular weight: 10000, degree of saponification: 80%) and 1.7 mass % of glycerin was used as the resin layer coating liquid.

### Resin Layer Coating Condition

The resin layer coating liquid was coated by spin coating on the exfoliation layer on the PET film. The coating was carried out under conditions that the resin layer coating liquid was dropwise applied onto the exfoliation layer on the PET film on a turntable, and the turntable was rotated at 500 rpm for 5 seconds and then at 2000 rpm for 30 seconds, followed by drying at 100° C. for 5 minutes. The resin layer formed under such conditions had a thickness of 10 μm.

### Formation of Color Material Layer

### Color Material Layer Coating Liquid

A color material layer coating liquid was prepared. IPA (isopropyl alcohol) containing 15.0 mass % of C.I. pigment yellow 110 (color material) as a color material, 5.0 mass % of S-LEC BL-10 (butyral resin manufactured by Sekisui Chemical Co., Ltd.) as a dispersant, and 5.0 mass % of glycerin was used as the color material layer coating liquid.

The color material layer coating liquid was prepared by dispersing a mixture of the color material, the dispersant, glycerin, and IPA in a sand mill (manufactured by Yasukawa Seisakusyo K.K.) with glass beads (diameter: 1.7 mm, an amount of 1.5 times (by weight) the weight of the mixture) for 2 hours and then removing the glass beads.

### Color Material Layer Coating Condition

The thus prepared color material layer coating liquid was applied onto the resin layer by spin coating, followed by drying to form a color material layer having a thickness of 150 nm.

### Formation of Aluminum Layer

An aluminum layer having a thickness of 70 nm was formed by depositing aluminum on the color material layer using a vacuum deposition device, model VE-1010, manufactured by Vacuum Device Inc.

### Formation of Color Material Layer

As in the formation of the color material layer described above, a color material layer was formed on the aluminum layer. The thickness of the resulting color material layer was also 150 nm.

### Formation of Resin Layer

As in the formation of the resin layer described above, a resin layer was formed on the color material layer. The thickness of the formed resin layer was 10 μm.

### 6.1.2.3. Properties of Base Substrate of Composite Pigment B

As in above, a base substrate of composite pigment B having a structure including an exfoliation layer and a pigment layer (resin layer/color material layer/aluminum layer/color material layer/resin layer) on a sheet-like base material was produced. It was confirmed by visual inspection that the base substrate of the composite pigment B was golden colored.

### 6.1.2.4. Exfoliation, Pulverization, and Dispersion

The PET film thus provided with a laminate of exfoliation layer/resin layer/color material layer/aluminum layer/color material layer/resin layer was simultaneously subjected to exfoliation, miniaturization, and dispersion treatment in ethylene glycol monoallyl ether using an ultrasonic disperser. Then, about 1 mL of an AG solution containing 0.4 mass % of citric acid was added to the resulting dispersion, followed by reaction at 60° C. for 4 hours.

As in above, the composite pigment B and undiluted dispersion containing the composite pigment B were prepared. The composite pigment B corresponds to the composite pigment of the fourth aspect described in the embodiment section.

### 6.1.3. Preparation of Photocurable Ink Composition for Ink Jet Recording

The thus prepared undiluted dispersions of the composite pigment A and the composite pigment B were each filtered through an SUS mesh filter with pore size of 5 μm to remove coarse particles. Then, each filtrate was put in a round-bottomed flask, and an excess of ethylene glycol monoallyl ether was evaporated using a rotary evaporator. By doing so, each of the undiluted dispersions was concentrated. The content (concentration) of the metallic pigment in each of the concentrated dispersions was adjusted to 5 mass % while measuring the concentration of the metallic pigment in the metallic pigment dispersion with a thermo mechanical analyzer (model EXSTAR-6000TG/DTA manufactured by SII Nano Technology Inc.) to give 5 mass % metallic pigment dispersion A and 5 mass % metallic pigment dispersion B.

The 50% average particle diameter R50 based on a circle-equivalent diameter of the X (major axis)-Y (minor axis) plane of the metallic pigment was measured using a particle diameter and particle size distribution analyzer (FPIA-3000S, manufactured by Sysmex Corp.). Furthermore, R50/Z was calculated from the measurement values R50 and Z (thickness).

As the results, the metallic pigment in this Example had an R50 of 1.03 μm and an R50/Z of 51.5.

The photocurable ink composition for ink jet recording for each Example was prepared so as to have the following composition using the metallic pigment dispersion A or the metallic pigment dispersion B prepared by the above-described processes. Hereinafter, the blending ratios are shown by mass %.

### EXAMPLE 1

Composite pigment dispersion A (in terms of the solid content): 1.0%

Cyracure UVI-6692 (polymerization initiator, manufactured by Dow Chemical Company): 5.0%

Cyracure UVR-6105 (oligomer, manufactured by Dow Chemical Company): 10.0%

BYK-UV3570 (polyester-modified silicone surfactant, manufactured by BYK Chemie Japan K.K.): 0.5%

3-Ethyl-3-(2-ethylhexyloxymethyl)oxetane (polymerizable compound, manufactured by Toagosei Co., Ltd.): the balance

### EXAMPLE 2

Composite pigment dispersion B (in terms of solid content): 1.0%

Cyracure UVI-6692: 5.0%

Cyracure UVR-6105: 10.0%

BYK-UV3570: 0.5%

3-Ethyl-3-(2-ethylhexyloxymethyl)oxetane: the balance

### EXAMPLE 3

Composite pigment dispersion A (in terms of solid content): 1.0%

Viscoat #1000 (polymerizable compound, manufactured by Osaka Organic Chemical Industry Ltd.): 25%

Irgacure 819 (polymerization initiator, manufactured by Ciba Specialty Chemicals Inc.): 3.4%

Irgacure 127 (polymerization initiator, manufactured by Ciba Specialty Chemicals Inc.): 1.6%

BYK-UV3570: 0.2%

Irgastab UV-10 (thermal radical polymerization inhibitor, manufactured by Ciba Specialty Chemicals Inc.): 0.2%

Ethylene glycol monoallyl ether (polymerizable compound, manufactured by Osaka Organic Chemical Industry Ltd.): the balance

### EXAMPLE 4

Composite pigment dispersion B (in terms of solid content): 1.0%

Viscoat #1000: 25%

Irgacure 819: 3.4%

Irgacure 127: 1.6%

BYK-UV3570: 0.2%

Irgastab UV-10: 0.2%

Ethylene glycol monoallyl ether: the balance

The components shown above, other than the metallic pigment, were mixed and dissolved, and then the metallic pigment dispersion A or the metallic pigment dispersion B prepared by the above-described process was added thereto. The resulting mixture was further mixed by stirring at ordinary temperature and pressure for 120 minutes with a magnetic stirrer to give each photocurable ink composition for ink jet recording of Examples 1 to 4.

### 6.2. Comparative Example

In a Comparative Example, an ink composition containing metallic particles not having a plate-like shape was used as the metallic pigment. As the metallic pigment of the Comparative Example, aluminum particles contained in commercially available aluminum paste (WXM0650, manufactured by Toyo Aluminum K.K.) were used. The metallic particles of the Comparative Example have a spherical shape and an average particle diameter of 6 μm.

The ink composition of the Comparative Example was produced at the same blending ratios (the blending ratio of metallic pigment was that as solid content) as those in Example 1 except that the metallic pigment was an aluminum particle not having the above-mentioned laminated plate-like shape.

### 6.3. Preparation of Evaluation Sample

### 6.3.1. Cured Matter of Ink Composition

The ink composition of each of Examples and Comparative Example was dropwise applied onto a glass substrate. Then, each composition was subjected to curing treatment under conditions such that the accumulated amount of light at a wavelength of 365 nm was 1000 mJ/cm² using an ultraviolet irradiation light source to obtain cured matter of the ink composition of each of Examples and Comparative Example.

### 6.3.2. Recorded Matter by Ink Jet Recording Method

The ink composition of each Example was set in the black column of an ink jet printer, SV300V, manufactured by Roland D.G. Corp., and solid printing of 10 cm×10 cm was carried out on a recording medium (A4 sized vinyl chloride sheet, SPVC-G-1270T, manufactured by Roland D.G. Corp.) using each ink composition at an amount of 0.9 mg/cm².

The resulting solid pattern was subjected to curing treatment under conditions such that the accumulated amount of light at a wavelength of 365 nm was 1000 mJ/cm² using an ultraviolet irradiation unit installed in a paper ejection port of an ink jet printer to obtain recorded matter of each Example.

It was tried to print the same solid pattern as in Examples using the ink composition of Comparative Example, but printing was not performed with the ink jet printer. Accordingly, bar coat printing was carried out using the ink composition at an amount of 0.9 mg/cm² with a wire bar (#3 wire bar manufactured by RK Print Coat Instrument Ltd.) to obtain recorded matter of Comparative Example.

### 6.4. Evaluation of Cured Matter and Recorded Matter

The cured matter of each of Examples and Comparative Examples produced in the section “6.3.1. Cured matter of ink composition” was examined by touching with finger. As the results, no tackiness was observed in every cured matter of Examples to reveal satisfactory curing. On the other hand, the cured matter of Comparative Example exhibited tackiness to reveal insufficient curing.

The recorded matter of each of Examples and Comparative Examples produced in the section “6.3.2. Recorded matter by ink jet recording method” was visually examined to evaluate the surface. It was recognized that every recorded matter of each Example had satisfactory metallic gloss. On the other hand, the metallic glossiness of the recorded matter of Comparative Example was inferior to that of Examples.

As described above, it has been revealed that since the photocurable ink composition for ink jet recording in each Example includes a composite pigment having a structure in which a metal or alloy layer is covered with a silicon oxide layer or a resin layer, a printed surface having a glossy metallic surface with high glossiness can be formed on a recording medium. Furthermore, it has been revealed that in every photocurable ink composition for ink jet recording of Examples, photopolymerization of the polymerizable compound in the printed surface can sufficiently proceed with light irradiation. In addition, it has been revealed that every photocurable ink composition for ink jet recording of Examples can be suitably applied to an ink jet recording method.

The invention is not limited to the above-described embodiment, and various modifications are applicable. For example, the invention includes substantially the same configurations as those described in the embodiment (for example, configurations having the same functions, processes, and results, or configurations having the same purposes and effects). Furthermore, the invention includes configurations in which portions not being essential of the configurations described in the embodiment are substituted. Furthermore, the invention includes configurations that can achieve the same effects or purposes as those of the configurations described in the embodiment. Furthermore, the invention includes configurations in which publicly known technology is added to the configurations described in the embodiment.

1. A method for ink jet recording comprising
(a) providing a photocurable ink composition for ink jet recording comprising:
a metallic pigment;
a polymerizable compound; and
a polymerization initiator, wherein
the metallic pigment is a plate-like particle composed of a laminate including:
a metal or alloy layer; and
at least one selected from a resin layer and a silicon oxide layer wherein
the plate-like particle has a shape having a flat surface with a major axis X and a minor axis Y and a thickness Z that satisfy the requirements that the 50% average particle diameter R50 based on a circle-equivalent diameter determined from the X-Y plane area of the plate-like particle is 0.5 to 3 μm and R50/Z>5
(b) ejecting the photocurable ink composition onto a recording medium;
(c) irradiating the ejected ink composition with light from an ultraviolet light-emitting diode to cure the ink composition, wherein the irradiated light has a wavelength of 350 nm to 450 nm and is irradiated in an amount of 50 mJ/cm² to 15000 mJ/cm².

2. The method for ink jet recording according to claim 1, wherein the metallic pigment further includes a color material layer between the metal or alloy layer and the resin layer or the silicon oxide layer.

3. (canceled)

4. The method for ink jet recording according to claim 1, wherein the metal or alloy layer is made of aluminum or an aluminum alloy.

5. The method for ink jet recording according to claim 1, wherein the polymerizable compound is a cationic polymerization compound.

6. The method for ink jet recording according to claim 1, wherein the polymerizable compound is a radical polymerization compound.

7. The method for ink jet recording according to claim 6, further comprising a hindered amine compound.

8. The method for ink jet recording according to claim 1, wherein the metal or alloy layer of the metallic pigment have an end face treated by chemical conversion.

9. The method for ink jet recording according to claim 1, wherein transmittance of light having a wavelength of 350 to 400 nm in the thickness direction of the metal or alloy layer is at least 0.5% or more.

10. The method for ink jet recording according to claim 1, wherein the end face of the metal or alloy layer comprises a chemically stable layer that protects the pigment from corrosion, said layer being formed by treating a metal or alloy layer having a bared surface with a chemical oxidant to form the chemically stable layer.
